(19) United States
(12) Patent Application Publication
(10) Pub. No.: US 2016/0250916 A1
(43) Pub. Date: Sep. 1, 2016

(54) VEHICLE DRIVE DEVICE

(71) Applicant: AISIN AW CO., LTD., Anjo-shi, Aichi-ken (JP)

(72) Inventors: Takahisa HIRANO, Anjo (JP); Shigeki TAKAMI, Anjo (JP)

(73) Assignee: AISIN AW CO., LTD., Anjo-shi, Aichi-ken (JP)

(21) Appl. No.: 15/030,784

(22) PCT Filed: Dec. 24, 2014
(86) PCT No.: PCT/JP2014/084112

§ 371 Date: Apr. 20, 2016

(30) Foreign Application Priority Data
Dec. 26, 2013 (JP) 2013-269728
Mar. 19, 2014 (JP) 2014-056579

(51) Int. Cl. B60K 6/50; B60K 6/365; B60K 6/26; F16H 37/08

(52) U.S. Cl. CPC B60K 6/50; F16H 37/0806; B60K 6/365; B60K 6/26; Y10S 903/91; Y10S 903/951; B60Y 2200/92; B60Y 2400/60; B60Y 2400/80; B60Y 2400/73

(57) ABSTRACT

The axial length along the rotation axis of a second rotary electric machine is reduced. Embodiments relate to a vehicle drive device of a multi-axis configuration that includes a differential gear device, a first rotary electric machine, a second rotary electric machine, and an output device. Assumed maximum transmission torques and radii of respective first output gear and second output gear are set such that a tangential force in the case where the assumed maximum transmission torque is transmitted to the first output gear is less than a tangential force in the case where the assumed maximum transmission torque is transmitted to the second output gear.

### TECHNICAL FIELD

Aspects of preferred embodiments relate to a vehicle drive device that includes an input member drivingly coupled to an internal combustion engine via a damper, a first rotary electric machine, a second rotary electric machine, a differential gear device, and an output device drivingly coupled to wheels.

### BACKGROUND ART

A device disclosed in Japanese Patent Application Publication No. 2013-166548 (Patent Document 1) has been known as an example of the vehicle drive device described above. In the device of Patent Document 1, a rotation axis of an input member, a first rotary electric machine, and a differential gear device, a rotation axis of a second rotary electric machine, and a rotation axis of an output device are disposed parallel to each other and located on vertices of a triangle as viewed in the axial direction. Further, a gear that rotates together with an output element of the differential gear device and an output gear of the second rotary electric machine mesh with a common gear of a counter gear mechanism disposed inside the triangle. However, in the device of Patent Document 1, a damper and the counter gear mechanism are disposed to overlap each other as viewed in the axial direction, and the counter gear mechanism and the second rotary electric machine are disposed to overlap each other as viewed in the axial direction. Therefore, the axial length along the rotation axis of the second rotary electric machine tends to be large.

Japanese Patent Application Publication No. 2001-246953 (Patent Document 2) discloses a device which has the same premise configuration and in which a power transmission system from a differential gear device side to an output device and a power transmission system from a second rotary electric machine side are provided separately. Since the two separate power transmission systems are provided for the output device, it is possible to set the total gear ratio without changing the position of each axis, and it is also possible to reduce the constraints on mounting on a vehicle. However, Patent Document 2 does not refer at all to a damper that may be disposed between an internal combustion engine and the differential gear device, and no consideration is given to the effects of the presence of such a damper on the arrangement of the surrounding members. However, if the presence of such a damper is taken into consideration, it is difficult to arrange, in positions close to the internal combustion engine side, at least members overlapping the damper as viewed in the axial direction. Therefore, if two power transmission systems are simply provided separately without taking any special measures, the axial length along the rotation axis of the second rotary electric machine tends to be large as in the case of the device of Patent Document 1.

### RELATED-ART DOCUMENTS

### Patent Documents

[Patent Document 1] Japanese Patent Application Publication No. 2013-166548 (JP 2013-166548 A)

[Patent Document 2] Japanese Patent Application Publication No. 2001-246953 (JP 2001-246953 A)

### SUMMARY

In view of the foregoing, it is desired to reduce the axial length along the rotation axis of a second rotary electric machine in a drive device of a multi-axis configuration that is coupled to a damper.

### MEANS FOR SOLVING THE PROBLEM

A vehicle drive device according to a preferred embodiment includes an input member drivingly coupled to an internal combustion engine via a damper, a first rotary electric machine, a second rotary electric machine, a differential gear device having three rotary elements, and an output device drivingly coupled to wheels, wherein: the input member is drivingly coupled to a first one of the three rotary elements of the differential gear device; the first rotary electric machine is drivingly coupled to a second one of the rotary elements; and an output element as a third one of the rotary elements is drivingly coupled to the output device; and the second rotary electric machine is drivingly coupled to the output device, the vehicle drive device including:

a first gear mechanism including a first gear meshing with a first output gear that rotates together with the output element, and a second gear meshing with an input gear of the output device in a different axial position from the first gear; and

a second gear mechanism including a third gear meshing with a second output gear of the second rotary electric machine, and a fourth gear meshing with the input gear in a different axial position from the third gear; wherein:

the damper, the differential gear device, and the first rotary electric machine are arranged on a common first axis;

the second rotary electric machine is disposed on a second axis parallel to the first axis and different from the first axis;

the output device is disposed on a third axis parallel to the first axis and different from the first axis and the second axis;

the first gear mechanism is disposed on a fourth axis parallel to the first axis and different from the first axis, the second axis, and the third axis;

the second gear mechanism is disposed on a fifth axis parallel to the first axis and located on a side opposite to a first axis side with respect to a reference plane, the reference plane being a plane containing both the second axis and the third axis;

the third gear is disposed on a side opposite to a second rotary electric machine side with respect to the fourth gear in an axial direction; and

an assumed maximum transmission torque and a radius of each of the first output gear and the second output gear are set such that a first maximum tangential force is less than a second maximum tangential force, the first maximum tangential force being a tangential force in a case where the assumed maximum transmission torque is transmitted to the first output gear, the second maximum tangential force being a tangential force in a case where the assumed maximum transmission torque is transmitted to the second output gear.

In the following description, the term “drivingly coupled” refers to a state in which two rotary elements are coupled to each other in such a way that allows transmission of a drive force (synonymous with torque), which includes a state in which the two rotary elements are coupled to each other to rotate together, and a state in which the two rotary elements are coupled to each other via one or more transmission members in such a way that allows transmission of a drive force. Examples of such transmission members include various members that transmit rotation at the same speed or a different speed (such as a shaft, a gear mechanism, and a belt), and may include engagement devices that selectively transmit rotation and a drive force (such as a friction engagement device and a meshing-type engagement device). However, in the case where the term “drivingly coupled” is used in connection with each rotary element of the differential gear device, the term refers to a state in which the rotary element is drivingly coupled without interposing any of the other rotary elements of the differential gear device.

Further, the term “rotary electric machine” refers to any of a motor (electric motor), a generator (electric generator), and a motor generator that serves as both a motor and a generator as necessary.

According to this configuration, since the first gear mechanism that transmits a drive force between the output element and the output device and the second gear mechanism that transmits a drive force between the second rotary electric machine and the output device are provided separately from each other, it is possible to reduce the constraints on the arrangement of each gear mechanism, as compare to the case where a single gear mechanism serving as both of these gear mechanisms is provided. In particular, although the second gear mechanism tends to be axially elongated due to having a gear meshing with the second output gear with a large maximum tangential force (the second maximum tangential force), the second gear mechanism can be disposed away from the damper that is disposed coaxially with the internal combustion engine. That is, since the second gear mechanism is disposed on the fifth axis located on the side opposite to the first axis side with respect to the reference plane containing both the second axis and the third axis, the second gear mechanism can be disposed away from the damper as viewed in the axial direction. Further, since the third gear is disposed on the side opposite to the second rotary electric machine side with respect to the fourth gear in the axial direction, the third gear can be disposed on the side opposite to the second rotary electric machine side with respect to the input gear of the output device. Thus, the second gear mechanism and the second rotary electric machine can be disposed close to the damper side in the axial direction.

Further, according to the configuration described above, since the assumed maximum transmission torque and the radius of each of the first output gear and the second output gear are set such that the first maximum tangential force is less than the second maximum tangential force, the gear width of the first output gear can be set to be less than the gear width of the second output gear. Consequently, the axial length of the first gear mechanism can be reduced in accordance with a reduction in the gear width of the first output gear. Thus, the members around the first gear mechanism can be disposed closer to the damper side in the axial direction, and hence the second rotary electric machine can be disposed closer to the damper side in the axial direction.

Accordingly, the axial length along the rotation axis of the second rotary electric machine of the vehicle drive device can be reduced.

Further, according to the configuration described above, the assumed maximum transmission torque of each of the first output gear and the second output gear is set such that the first maximum tangential force is less than the second maximum tangential force. Thus, the reduction ratio of the power transmission system from the internal combustion engine to the first output gear is set to be relatively small, and the reduction ratio of the power transmission system from the second rotary electric machine to the second output gear is set to be relatively large. Accordingly, the speed of rotation of the second rotary electric machine is relatively greatly reduced, so that relatively high torque can be transmitted from the second rotary electric machine to the output device. Meanwhile, the rotation of the internal combustion engine is transmitted to the output device without greatly reducing its speed, so that the rotational speed of the internal combustion engine can be maintained relatively low. Thus, it is possible to improve the fuel efficiency performance of the vehicle.

In the following, preferred embodiments will be described. However, the scope of the present invention is not limited to the preferred embodiments described below.

In one aspect, it is preferable that a gear width of the first output gear and the first gear is less than a gear width of the second output gear and the third gear.

According to this configuration, the second rotary electric machine can actually be disposed closer to the damper side in the axial direction, and the axial length along the rotation axis of the second rotary electric machine of the vehicle drive device can be effectively reduced.

In one aspect, it is preferable that a virtual structure is assumed in which a virtual gear mechanism is provided in place of the first gear mechanism and the second gear mechanism, the virtual gear mechanism including a fifth gear meshing with both the first output gear and the second output gear, and a sixth gear meshing with the input gear in a different axial position from the fifth gear, and a gear width of the input gear is set to be less than a gear width of the input gear that is set in accordance with a tangential force on the input gear in a case where an assumed maximum transmission torque is transmitted to the sixth gear in the virtual structure.

According to this configuration, the gear width of the input gear is set to be less compared to the virtual structure in which both the torque from the differential gear device to the first output gear and the torque from the second rotary electric machine to the second output gear are transmitted to the input gear via the common virtual gear mechanism. Consequently, the gear width of the second gear and the fourth gear meshing with the input gear can also be reduced. Thus, the axial length of the first gear mechanism can be further reduced, and the axial length of the second gear mechanism can also be reduced. Accordingly, the second rotary electric machine can be disposed closer to the damper side in the axial direction, and the axial length along the rotation axis of the second rotary electric machine of the vehicle drive device can be further reduced.

In one aspect, it is preferable that the second gear mechanism is disposed so as to overlap a damper housing that accommodates the damper as viewed in a radial direction, without overlapping the damper housing as viewed in the axial direction.

According to this configuration, it is possible to prevent interference between the second gear mechanism and the damper housing and the damper accommodated therein. Thus, the second gear mechanism can be disposed close to the damper side and hence the internal combustion engine side. Further, by actually disposing the second gear mechanism close to the internal combustion engine side such that the second gear mechanism and the damper housing overlap as viewed in the radial direction, the axial length along the rotation axis of the second rotary electric machine of the vehicle drive device can be effectively reduced.

In one aspect, it is preferable that the first gear is disposed on a damper side with respect to the second gear in the axial direction.

According to this configuration, since the third gear is disposed on the side opposite to the second rotary electric machine side with respect to the fourth gear in the axial direction, it is possible to prevent the output device and the second gear mechanism from excessively protruding toward the internal combustion engine. Thus, it is possible to satisfactorily accommodate the entire device, while reducing the axial length along the rotation axis of the second rotary electric machine.

In one aspect, it is preferable that in a vehicle-mounted state, the second axis and the third axis are disposed on one horizontal side with respect to the first axis, and the second axis is disposed above the third axis.

According to this configuration, it is possible to reduce the axial length along the rotation axis of the second rotary electric machine of the vehicle drive device, while achieving a layout suitable for a vehicle drive device of a multi-axis configuration.

Another vehicle drive device according to a preferred embodiment includes an input member drivingly coupled to an internal combustion engine via a damper, a first rotary electric machine, a second rotary electric machine, a differential gear device having three rotary elements, and an output device drivingly coupled to wheels, wherein: the input member is drivingly coupled to a first one of the three rotary elements of the differential gear device; the first rotary electric machine is drivingly coupled to a second one of the rotary elements; and an output element as a third one of the rotary elements is drivingly coupled to the output device; and the second rotary electric machine is drivingly coupled to the output device, the vehicle drive device including:

a first gear mechanism including a first gear meshing with a first output gear that rotates together with the output element, and a second gear meshing with an input gear of the output device in a different axial position from the first gear; and

a second gear mechanism including a third gear meshing with a second output gear of the second rotary electric machine, and a fourth gear meshing with the input gear in a different axial position from the third gear; wherein:

the damper, the differential gear device, and the first rotary electric machine are arranged on a common first axis;

the second rotary electric machine is disposed on a second axis parallel to the first axis and different from the first axis;

the output device is disposed on a third axis parallel to the first axis and different from the first axis and the second axis;

the first gear mechanism is disposed on a fourth axis parallel to the first axis and different from the first axis, the second axis, and the third axis;

the second gear mechanism is disposed on a fifth axis parallel to the first axis and located on a side opposite to a first axis side with respect to a reference plane, the reference plane being a plane containing both the second axis and the third axis;

the third gear is disposed on a side opposite to a second rotary electric machine side with respect to the fourth gear in an axial direction; and

a gear width of the first output gear and the first gear is less than a gear width of the second output gear and the third gear.

According to this configuration, since the first gear mechanism that transmits a drive force between the output element and the output device and the second gear mechanism that transmits a drive force between the second rotary electric machine and the output device are provided separately from each other, it is possible to reduce the constraints on the arrangement of each gear mechanism, as compare to the case where a single gear mechanism serving as both of these gear mechanisms is provided. Further, since the second gear mechanism is disposed on the fifth axis located on the side opposite to the first axis side with respect to the reference plane containing both the second axis and the third axis, the second gear mechanism can be disposed away from the damper as viewed in the axial direction. Further, since the third gear is disposed on the side opposite to the second rotary electric machine side with respect to the fourth gear in the axial direction, the second gear mechanism can be disposed on the side opposite to the second rotary electric machine side with respect to the input gear of the output device. Thus, the second gear mechanism and the second rotary electric machine can be disposed close to the damper side in the axial direction.

Further, according to the configuration described above, since the gear width of the first output gear and the first gear is less than the gear width of the second output gear and the third gear, the axial length of the first gear mechanism can be reduced in accordance with a reduction in the gear width of the first gear. Thus, the members around the first gear mechanism can be disposed closer to the damper side in the axial direction, and hence the second rotary electric machine can be disposed closer to the damper side in the axial direction.

Accordingly, the axial length along the rotation axis of the second rotary electric machine of the vehicle drive device can be reduced.

It is obvious that some of the additional techniques described above as preferred aspects may be incorporated in this vehicle drive device. In this case, advantageous effects corresponding to the respective additional techniques can be obtained.

### BRIEF DESCRIPTION OF THE DRAWINGS

FIG. 1 is a skeleton diagram illustrating a vehicle drive device according to an embodiment.

FIG. 2 is a velocity diagram of a differential gear device.

FIG. 3 is a schematic diagram illustrating the arrangement of components as viewed in the axial direction.

FIG. 4 is a cross-sectional view illustrating the vehicle drive device.

FIG. 5 is a conceptual diagram illustrating the relationship between tangential forces on respective output gears.

FIG. 6 is a skeleton diagram illustrating a vehicle drive device according to a virtual structure (comparative example).

FIG. 7 is a cross-sectional view illustrating a vehicle drive device according to another aspect.

FIG. 8 is a schematic diagram illustrating the arrangement of components as viewed in the axial direction according to another aspect.

FIG. 9 is a skeleton diagram illustrating a differential gear device according to another aspect.

FIG. 10 is a skeleton diagram illustrating a differential gear device according to another aspect.

### DESCRIPTION

A vehicle drive device according to an embodiment will be described with reference to the drawings. A vehicle drive device 1 according to the present embodiment is a hybrid vehicle drive device that includes both an internal combustion engine E and rotary electric machines MG1 and MG2 as the drive power sources for wheels W. The vehicle drive device 1 is formed as a hybrid vehicle drive device of a so-called two-motor split type. Further, the vehicle drive device 1 according to the present embodiment is formed as a drive device for a Front Engine Front Drive (FF) vehicle.

Note that in the following description, terms related to the direction, the location, and so on of each member may allow differences due to acceptable manufacturing errors. Further, the direction of each member indicates the direction of each member mounted in the vehicle drive device 1.

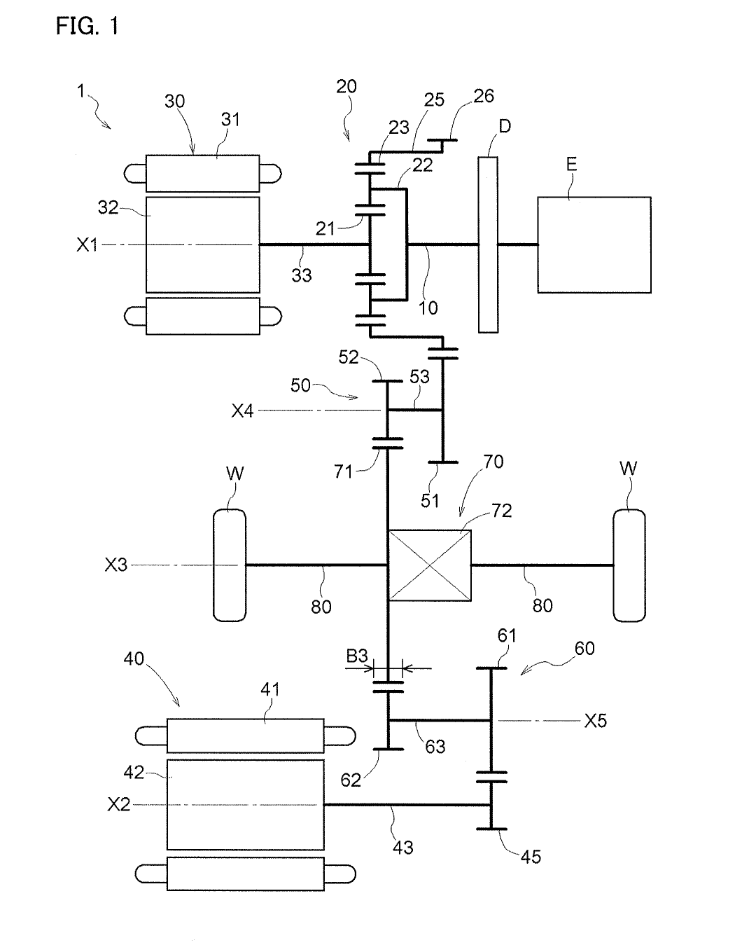

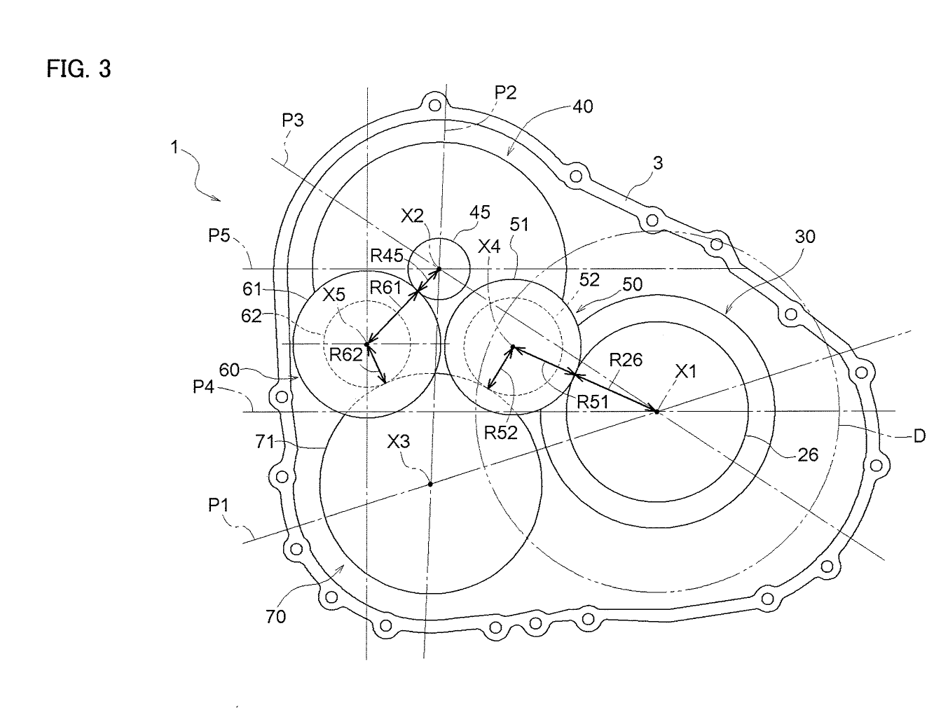

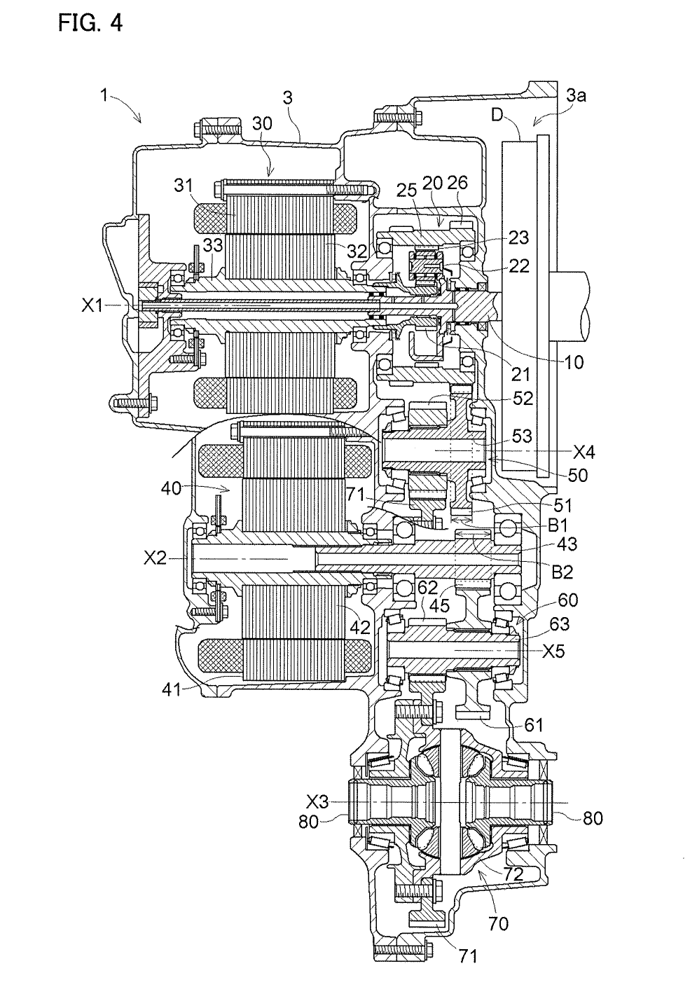

As illustrated in FIG. 1, the vehicle drive device 1 includes an input shaft 10 drivingly coupled to the internal combustion engine E, a differential gear device 20, a first rotary electric machine 30, a second rotary electric machine 40, and an output device 70 drivingly coupled to the wheels W. The vehicle drive device 1 further includes separately a first gear mechanism 50 that transmits a drive force between the differential gear device 20 and the output device 70, and a second gear mechanism 60 that transmits a drive force between the second rotary electric machine 40 and the output device 70. As illustrated in FIGS. 3 and 4, these components are accommodated in a case (a drive device case) 3. Note that as illustrated in FIG. 4, a damper housing 3a is formed in the case 3, and a damper D is accommodated in the damper housing 3a.

As illustrated in FIGS. 1 and 4, the input shaft 10, the differential gear device 20, and the first rotary electric machine 30 are disposed on a common first axis X1. The input shaft 10, the differential gear device 20, and the first rotary electric machine 30 are arranged on the first axis X1 in this order from the internal combustion engine E side. The second rotary electric machine 40 is disposed on a second axis X2 different from the first axis X1. The output device 70 is disposed on a third axis X3 different from the first axis X1 and the second axis X2. The first axis X1, the second axis X2, and the third axis X3 are arranged parallel to each other. In the present embodiment, a direction parallel to these axes X1 through X3 is defined as an “axial direction”.

As illustrated in FIG. 3, the first axis X1, the second axis X2, and the third axis X3 are located on the vertices of a triangle as viewed in the axial direction. In the present embodiment, the second axis X2 and the third axis X3 are disposed on one horizontal side with respect to the first axis X1, in a vehicle-mounted state as viewed in the axial direction. The second axis X2 and the third axis X3 are disposed in a substantially same horizontal position as viewed in the axial direction. Further, the second axis X2 is disposed above the third axis X3. In the present embodiment, the third axis X3 is located below the first axis X1, while the second axis X2 is located above the first axis X1.

The input shaft 10 is drivingly coupled to the internal combustion engine E. The internal combustion engine E is a motor (such as a gasoline engine and a diesel engine) that is driven by combustion of fuel inside the engine so as to take out power. In the present embodiment, the input shaft 10 is drivingly coupled to an output shaft (an internal combustion engine output shaft such as a crankshaft) of the internal combustion engine E. Further, the input shaft 10 is drivingly coupled to the internal combustion engine E, via the damper D that is disposed on the same axis (the first axis X1) as the input shaft 10. Note that it is also preferable that the input shaft 10 is drivingly coupled to the internal combustion engine E via a clutch and the like in addition to the damper D. In the present embodiment, the input shaft 10 corresponds to an “input member.”

The input shaft 10 is drivingly coupled to the differential gear device 20. The differential gear device 20 is formed of a planetary gear mechanism including three rotary elements, namely, a sun gear 21, a carrier 22, and a ring gear 23. The differential gear device 20 includes the carrier 22 that supports a plurality of pinion gears, and the sun gear 21 and the ring gear 23 that respectively mesh with the pinion gears. In the present embodiment, the differential gear device 20 is formed of a single-pinion type planetary gear mechanism. Further, in the present embodiment, the three rotary elements of the differential gear device 20 include the sun gear 21, the carrier 22, and the ring gear 23 in order of rotational speed.

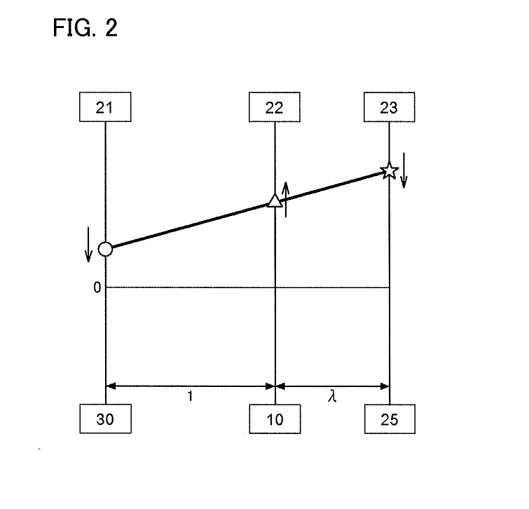

The term “order of rotational speed” refers to the order of rotational speed of each of the rotary elements 21 through 23 in a rotating state. Although the rotational speed of each of the rotary elements 21 through 23 changes in accordance with the rotating state of the differential gear device 20, the order of rotational speed of each of the rotary elements 21 through 23 is determined by the structure of the differential gear device 20, and therefore is fixed. Note that the order of rotational speed of each of the rotary elements 21 through 23 is the same as the order of arrangement of each of the rotary elements 21 through 23 in the velocity diagram (also referred to as a “collinear chart”, see FIG. 2).

In the present embodiment, the first rotary electric machine 30 is drivingly coupled to the sun gear 21; the input shaft 10 is drivingly coupled to the carrier 22; and the output device 70 is drivingly coupled to the ring gear 23. The first rotary electric machine 30 is drivingly coupled to the sun gear 21 without interposing the carrier 22 or the ring gear 23 therebetween; the input shaft 10 is drivingly coupled to the carrier 22 without interposing the sun gear 21 or the ring gear 23 therebetween; and the output device 70 is drivingly coupled to the ring gear 23 without interposing the sun gear 21 or the carrier 22 therebetween. In the present embodiment, the ring gear 23 corresponds to an “output element.”

FIG. 2 is a velocity diagram illustrating the operational state of the differential gear device 20. In the velocity diagram, the vertical axis corresponds to the rotational speed of each rotary element. Here, “0” indicates that the rotational speed is zero. The rotation speed is positive at the upper side, and is negative at the lower side. A plurality of parallel vertical lines correspond to the rotary elements 21 through 23 of the differential gear device 20, respectively. Further, the intervals between the vertical lines corresponding to the rotary elements 21 through 23 correspond to a gear ratio λ (the ratio of the number of teeth of the sun gear 21 to the number of teeth of the ring gear 23=(the number of teeth of the sun gear 21)/(the number of teeth of the ring gear 23)) of the differential gear device 20. Further, the bold solid straight line indicates the operational state of the differential gear device 20.

The differential gear device 20 distributes, to the first rotary electric machine 30 and the ring gear 23, the torque of the internal combustion engine E transmitted to the input shaft 10. That is, in the differential gear device 20, the carrier 22 that is in the middle in order of rotational speed is drivingly coupled to the input shaft 10 so as to rotate together therewith, and thus the torque of the input shaft 10 (the internal combustion engine E) transmitted to the carrier 22 is distributed to the sun gear 21 that is at one end in order of rotational speed and the ring gear 23 that is at the other end in order of rotational speed. Torque attenuated with respect to the torque of the internal combustion engine E is transmitted to the sun gear 21 as torque for generating electricity. The first rotary electric machine 30 mainly outputs reaction torque (regenerative torque) with respect to the torque distributed to the sun gear 21 so as to generate electricity. Torque attenuated with respect to the torque of the internal combustion engine E is transmitted to the ring gear 23 as torque for driving the wheels W. In the present embodiment, the differential gear device 20 functions as a power distribution device (a differential gear device for power distribution).

As illustrated in FIGS. 1 and 4, in the present embodiment, the ring gear 23 is integrally formed on the inner periphery of a cylindrical differential output member 25, and a first output gear 26 is integrally formed on the outer periphery of the differential output member 25. In the present embodiment, the first output gear 26 is formed at an end on the internal combustion engine E and damper D side (the side opposite to the first rotary electric machine 30 side) in the differential output member 25. Thus, the ring gear 23 and the first output gear 26 are configured to rotate together. The first output gear 26 meshes with a first gear 51 of the first gear mechanism 50. The ring gear 23 and the first output gear 26 that rotates with the ring gear 23 are drivingly coupled to the output device 70 via the first gear mechanism 50.

The first rotary electric machine 30 includes a first stator 31 fixed to the case 2, and a first rotor 32 that is rotatably supported at the radially inner side of the first stator 31. The first rotor 32 is drivingly coupled to a first rotor shaft 33 so as to rotate together therewith. The sun gear 21 is formed at an end of the first rotor shaft 33 on the internal combustion engine E side. Thus, the first rotor 32 is drivingly coupled to the sun gear 21 of the differential gear device 20 via the first rotor shaft 33.

The first rotary electric machine 30 can function as a motor (an electric motor) that is supplied with electricity so as to generate power, and as a generator (an electric generator) that is supplied with power so as to generate electricity. The first rotary electric machine 30 is electrically connected to an electricity storage device (such as a battery or a capacitor, not illustrated). The first rotary electric machine 30 mainly functions as a generator that generates electricity using the torque of the input shaft 10 (the internal combustion engine E) which is input via the differential gear device 20 as described above. In some cases, such as when the vehicle travels at high speed and when the internal combustion engine E is started, the first rotary electric machine 30 functions as a motor.

The second rotary electric machine 40 includes a second stator 41 fixed to the case 2, and a second rotor 42 that is rotatably supported at the radially inner side of the second stator 41. The second rotor 42 is drivingly coupled to a second rotor shaft 43 so as to rotate together therewith. A second output gear 45 is formed at an end of the second rotor shaft 43 on the internal combustion engine E side. Thus, the second rotor 42 is drivingly coupled to the second output gear 45 via the second rotor shaft 43. The second output gear 45 meshes with a third gear 61 of the second gear mechanism 60. The second output gear 45 is drivingly coupled to the output device 70 via the second gear mechanism 60.

The second rotary electric machine 40 can also function as a motor and a generator, and is electrically connected to an electricity storage device (not illustrated). The second rotary electric machine 40 mainly functions as a motor (an assist motor) that assists in providing a drive force for the vehicle to travel. In some cases, such as when the vehicle decelerates, the second rotary electric machine 40 functions as a generator.

The first gear mechanism 50 transmits a drive force between the ring gear 23 serving as an output element of the differential gear device 20 and the output device 70. The first gear mechanism 50 includes the first gear 51, a second gear 52 that is disposed in an axial position different from that of the first gear 51, and a first connecting shaft 53 that connects the two gears 51 and 52 to each other. The first gear mechanism 50 is disposed on a fourth axis X4 parallel to the first axis X1 and different from the first axis X1, the second axis X2, and the third axis X3. The first gear 51 meshes with the first output gear 26 that rotates together with the ring gear 23. The second gear 52 meshes with an input gear 71 of the output device 70.

In the present embodiment, the first gear 51 is disposed on the internal combustion engine E side (the damper D side) with respect to the second gear 52 in the axial direction. Further, the second gear 52 is formed with a smaller diameter (a smaller number of teeth) than the first gear 51. That is, a reference pitch radius R52 of the second gear 52 is less than a reference pitch radius R51 of the first gear 51 (see FIG. 3). The term “reference pitch radius” as used herein refers to the radius of a circle whose circumference has a length obtained by multiplying a “pitch”, which serves as a reference of the size of teeth of each gear, by the number of teeth. In the present embodiment, the reference pitch radius of each gear corresponds to the “radius” of each gear in preferred embodiments. Note that there is substantially no difference even when the diameter of the reference pitch circle of each gear is regarded as the “diameter” of each gear. The first gear mechanism 50 functions as a first speed reduction mechanism (a counter speed reduction mechanism) that reduces the speed of the output rotation of the differential gear device 20 (and simultaneously amplifies the output torque of the differential gear device 20) to transmit the resultant rotation to the output device 70.

The second gear mechanism 60 transmits a drive force between the second rotary electric machine 40 and the output device 70. The second gear mechanism 60 includes the third gear 61, a fourth gear 62 that is disposed in an axial position different from that of the third gear 61, and a second connecting shaft 63 that connects the two gears 61 and 62 to each other. The second gear mechanism 60 is disposed on a fifth axis X5 parallel to the first axis X1 and different from the first axis X1, the second axis X2, the third axis X3, and the fourth axis X4. The third gear 61 meshes with the second output gear 45 of the second rotary electric machine 40. The fourth gear 62 meshes with the input gear 71 of the output device 70.

In the present embodiment, the third gear 61 is disposed on the side opposite to the second rotary electric machine 40 side with respect to the fourth gear 62 in the axial direction. In the present embodiment, the third gear 61 is disposed on the internal combustion engine E side (the damper D side) with respect to the fourth gear 62 in the axial direction. Further, the fourth gear 62 is formed with a smaller diameter (a smaller number of teeth) than the third gear 61. That is, a reference pitch radius R62 of the fourth gear 62 is less than a reference pitch radius R61 of the third gear 61 (see FIG. 3). The second gear mechanism 60 functions as a second speed reduction mechanism (a counter speed reduction mechanism) that reduces the speed of the output rotation of the second rotary electric machine 40 (and simultaneously amplifies the output torque of the second rotary electric machine 40) to transmit the resultant rotation to the output device 70.

In the present embodiment, a reduction ratio (a first reduction ratio) of the power transmission system from the differential gear device 20 to the output device 70 is set to be less than a reduction ratio (a second reduction ratio) of the power transmission system from the second rotary electric machine 40 to the output device 70. Note that the reduction ratio based on the ratio (R51/R52) of the reference pitch radii of the two gears 51 and 52 of the first gear mechanism 50 and the reduction ratio based on the ratio (R61/R62) of the reference pitch radii of the two gears 61 and 62 of the second gear mechanism 60 are set in the substantially same range (in the range of about 1.2 to 1.8), although there may be some differences. Therefore, in the present embodiment, the first reduction ratio is set to be less than the second reduction ratio based mainly on the magnitude relationship between a ratio (R51/R26) of the reference pitch radii of the first output gear 26 and the first gear 51 and the ratio (R61/R45) of the reference pitch radii of the second output gear 45 and the third gear 61.

In the present embodiment, the ratio (R51/R26) of the reference pitch radius R51 of the first gear 51 to the reference pitch radius R26 of the first output gear 26 is set to be significantly less than the ratio (R61/R45) of the reference pitch radius R61 of the third gear 61 to the reference pitch radius R45 of the second output gear 45. For example, the former (R51/R26) is set to be less than or equal to ½ of the latter (R61/R45), or is even less than or equal to ⅓. Note that such settings may be realized by making the reference pitch radius R26 of the first output gear 26 significantly greater than the reference pitch radius R45 of the second output gear 45 if the reference pitch radius R51 of the first gear 51 is substantially equal to the reference pitch radius R61 of the third gear 61 (R51≈R61) as in the present embodiment. In this manner, since the first reduction ratio is set to be relatively small, it is possible to maintain the rotational speed of the internal combustion engine E relatively low, and thus to improve the fuel efficiency characteristics. Further, since the second reduction ratio is set to be relatively large, it is possible to secure a large auxiliary drive power using a small second rotary electric machine 40.

In the present embodiment, assumed maximum transmission torques T1 and T2 and the reference pitch radii R26 and R45 of the respective first output gear 26 and second output gear 45 are set such that a first maximum tangential force F1 on the first output gear 26 is less than a second maximum tangential force F2 on the second output gear 45. The first maximum tangential force F1 is a tangential force in the case where the assumed maximum transmission torque T1 is transmitted to the first output gear 26. Further, the second maximum tangential force F2 is a tangential force in the case where the assumed maximum transmission torque T2 is transmitted to the second output gear 45. Note that the tangential force on each gear is calculated by dividing the torque transmitted to the gear by the reference pitch radius (and then multiplying the result by a coefficient if necessary).

As described above, the first output gear 26 is provided so as to rotate together with the ring gear 23 serving as an output element of the differential gear device 20, and the output torque of the differential gear device 20 is transmitted to the first output gear 26. Further, torque attenuated with respect to the torque of the internal combustion engine E is transmitted to the first output gear 26. The torque transmitted to the first output gear 26 is determined in accordance with the output torque of the internal combustion engine E and the gear ratio λ, of the differential gear device 20. In a two-motor split-type hybrid vehicle drive device as in the present embodiment, although the rotation and torque are controlled (to maintain a high efficiency, low emission state) so as to conform to the optimum fuel efficiency characteristics, the internal combustion engine E may output higher torque depending on the vehicle traveling status.

In this case, the first rotary electric machine 30 outputs reaction torque with respect to the torque of the internal combustion engine E distributed by the differential gear device 20. Thus, in the present embodiment, torque converted from the maximum torque of the internal combustion engine E in the specification in accordance with the gear ratio λ is the assumed maximum transmission torque T1 to the first output gear 26 (the maximum value of the torque that may be assumed to be transmitted to the first output gear 26). For example, the assumed maximum transmission torque T1 is represented by the following expression:

T1=(1/(1+λ))·Temax

where Temax is the maximum torque of the internal combustion engine E.

The second output gear 45 is connected to the second rotor 42 of the second rotary electric machine 40 so as to rotate together therewith, so that the output torque of the second rotary electric machine 40 is transmitted to the second output gear 45. In the present embodiment, the maximum torque of the second rotary electric machine 40 in the specification is the assumed maximum transmission torque T2 to the second output gear 45 (the maximum value of the torque that may be assumed to be transmitted to the second output gear 45).

As described above, in the present embodiment, in order to optimize the reduction ratios of the two power transmission systems, the reference pitch radius R26 of the first output gear 26 is set to be greater than the reference pitch radius R45 of the second output gear 45. These settings of the reference pitch radii R26 and R45 also contribute to making the first maximum tangential force F1 (=T1/R26) less than the second maximum tangential force F2 (=T2/R45). That is, optimization of the reduction ratios of the two power transmission systems and optimization of the relationship between the two maximum tangential forces F1 and F2 are correlated so as to achieve synergy effects.

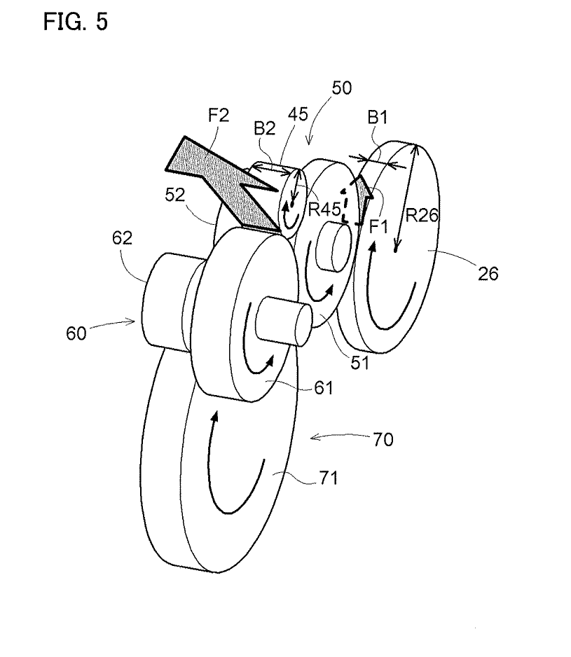

It is preferable that the assumed maximum transmission torques T1 and T2 and the reference pitch radii R26 and R45 of the respective first output gear 26 and second output gear 45 are set such that the first maximum tangential force F1 is significantly less than the second maximum tangential force F2. For example, it is preferable that the assumed maximum transmission torques T1 and T2 and the reference pitch radii R26 and R45 are set such that the second maximum tangential force F2 is two or more times as large as the first maximum tangential force F1. In the present embodiment, as conceptually illustrated in FIG. 5, the assumed maximum transmission torques T1 and T2 and the reference pitch radii R26 and R45 are set such that the second maximum tangential force F2 is about 2.3 to 2.5 times as large as the first maximum tangential force F1, for example. In this manner, by making the first maximum tangential force F1 less than the second maximum tangential force F2, it is possible to set a gear width B1 of the first output gear 26 to be less than a gear width B2 of the second output gear 45.

The power transmission system from the differential gear device 20 side and the power transmission system from the second rotary electric machine 40 side, which are provided separately from each other, meet at the output device 70. The output device 70 includes the input gear 71 and a main body unit 72 connected to the input gear 71. In the present embodiment, the main body unit 72 is disposed on the internal combustion engine E side (the damper D side) with respect to the input gear 71 in the axial direction. Both the second gear 52 of the first gear mechanism 50 and the fourth gear 62 of the second gear mechanism 60 mesh with the input gear 71 of the output device 70. The second gear 52 and the fourth gear 62 mesh with the input gear 71 in different positions in the circumferential direction about the third axis X3 (see FIG. 3).

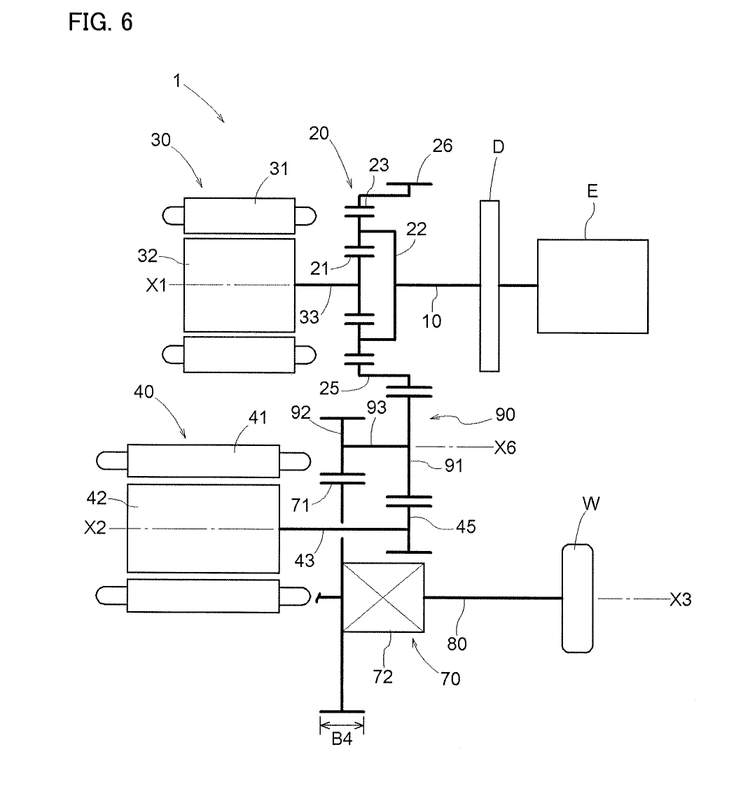

In the following, the settings of the gear width of the input gear 71 of the vehicle drive device 1 according to the present embodiment will be described while comparing with a virtual structure (a comparative example) illustrated in FIG. 6. In the virtual structure illustrated in FIG. 6, in place of the two counter gear mechanisms in the present embodiment, namely, the first gear mechanism 50 and the second gear mechanism 60, a virtual gear mechanism 90 is provided as a single counter gear mechanism that performs both transmission of a drive force between the differential gear device 20 and the output device 70 and transmission of a drive force between the second rotary electric machine 40 and the output device 70. The virtual gear mechanism 90 includes a fifth gear 91, a sixth gear 92 that is disposed in an axial position different from that of the fifth gear 91, and a third connecting shaft 93 that connects the two gears 91 and 92 to each other. The virtual gear mechanism 90 is disposed on a sixth axis X6 parallel to the first axis X1 and different from the first axis X1, the second axis X2, and the third axis X3. The fifth gear 91 meshes with both the first output gear 26 and the second output gear 45 of the second rotary electric machine 40. The sixth gear 92 meshes with the input gear 71 of the output device 70.

In the virtual structure, both the torque from the differential gear device 20 and the torque from the second rotary electric machine 40 are transmitted to the sixth gear 92. Accordingly, in the virtual structure, the gear width of the input gear 71 is set in accordance with the tangential force on the input gear 71 in the case where the assumed maximum transmission torque as the sum of the torque from the differential gear device 20 and the torque from the second rotary electric machine 40 is transmitted to the sixth gear 92. On the other hand, in the structure of the present embodiment, the input gear 71 meshes with each of the second gear 52 and the fourth gear 62 in different circumferential positions. Therefore, the gear width of the input gear 71 is set in accordance with a greater one of the tangential force on the input gear 71 in the case where the assumed maximum transmission torque from the differential gear device 20 is transmitted to the second gear 52 and the tangential force on the input gear 71 in the case where the assumed maximum transmission torque from the second rotary electric machine 40 is transmitted to the fourth gear 62. Accordingly, a gear width B3 (see FIG. 1) of the input gear 71 in the present embodiment can be set to be less than a gear width B4 of the input gear 71 in the virtual structure illustrated in FIG. 6.

The main body unit 72 includes a plurality of bevel gears meshing with each other and a storage case storing the bevel gears, and forms a differential gear mechanism. The output device 70 distributes, in the main body unit 72, the rotation and torque input from the differential gear device 20 side and the second rotary electric machine 40 side to the input gear 71 via the respective two independent gear mechanisms 50 and 60 so as to transmit the rotation and torque to the two right and left output shafts 80 (that is, the two right and left wheels W). The output device 70 serves as an output device (an output differential gear device) including a differential gear mechanism.

Thus, it is possible to cause the vehicle to travel with a part of the torque of the internal combustion engine E and (if necessary) the torque of the second rotary electric machine 40, while controlling the internal combustion engine E so as to conform to the optimum fuel efficiency characteristics and causing the first rotary electric machine 30 to generate electricity. As described above, the assumed maximum transmission torque of each of the first output gear 26 and the second output gear 45 is set such that the first maximum tangential force F1 is less than the second maximum tangential force F2. Therefore, the reduction ratio of the power transmission system from the internal combustion engine E to the first output gear 26 is set to be relatively small, and the reduction ratio of the power transmission system from the second rotary electric machine 40 to the second output gear 45 is set to be relatively large. Accordingly, the speed of rotation of the second rotary electric machine 40 is relatively greatly reduced, so that relatively high torque can be transmitted from the second rotary electric machine 40 to the output device 70. Meanwhile, the rotation of the internal combustion engine E is transmitted to the output device 70 without greatly reducing its speed, so that the rotational speed of the internal combustion engine E can be maintained relatively low. Thus, it is possible to improve the fuel efficiency performance of the vehicle.

In view of the vehicle mountability of the vehicle drive device 1, it is preferable that the size of the entire device is reduced as much as possible. In the case of the vehicle drive device 1 for an FF vehicle that is disposed adjacent to the internal combustion engine E in the vehicle width direction, it is preferable that the size of the entire device is reduced especially in the axial direction. This applies primarily to the components on the first axis X1 on which a plurality of component parts (the differential gear device 20, the first rotary electric machine 30, and the damper D) are arranged.

In this regard, in the present embodiment, as illustrated in FIG. 4, the entire differential gear device 20 is disposed inward of the cylindrical differential output member 25 so as to overlap the differential output member 25 as viewed in the radial direction about the first axis X1. Accordingly, the entire differential gear device 20 can be disposed in the axial space occupied by the differential output member 25. Further, since the first output gear 26 is integrally formed on the outer periphery of the differential output member 25, the first output gear 26 can also be disposed in the axial space occupied by the differential output member 25. Accordingly, by accommodating both the differential gear device 20 and the first output gear 26 within the space occupied by the differential output member 25, it is possible to reduce the axial length of the space occupied by the differential output member 25, the differential gear device 20, and the first output gear 26.

A reduction in axial length is required not only with respect to the components on the first axis X1 described above, but also with respect to the component (the second rotary electric machine 40) on the second axis X2. If the axial length along the second axis X2 can be reduced, the vehicle mountability can be further improved. Alternatively, a large rotary electric machine can be used as the second rotary electric machine 40 functioning mainly as an assist motor, without increasing the axial length along the second axis X2. Alternatively, these two advantages can be obtained in a balanced manner in accordance with the required specifications. In view of this, in the present embodiment, the power transmission system between the differential gear device 20 and the output device 70 and the power transmission system between the second rotary electric machine 40 and the output device 70 are provided separately, and the location of the latter is optimized.

Here, as illustrated in FIG. 3, in the present embodiment, a virtual plane containing both the first axis X1 and the third axis X3 is defined as a first reference plane P1. Further, a virtual plane containing the second axis X2 and the third axis X3 is defined as a second reference plane P2. Further, a virtual plane containing both the first axis X1 and the second axis X2 is defined as a third reference plane P3. Further, a virtual horizontal plane containing the first axis X1 is defined as a fourth reference plane P4. Further, a virtual horizontal plane containing the second axis X2 is defined as a fifth reference plane P5. In the present embodiment, the second reference plane P2 corresponds to a “reference plane.”

In the present embodiment, the fourth axis X4 as the rotation axis of the first gear mechanism 50 that transmits a drive force between the differential gear device 20 and the output device 70 is disposed inside a triangular prism-shaped space defined by the three reference planes P1 through P3. Further, the fourth axis X4 is disposed above the fourth reference plane P4. The major part of the first gear mechanism 50 is disposed inside a triangular prism-shaped space defined by the second reference plane P2, the third reference plane P3, and the fourth reference plane P4. The first gear mechanism 50 partially overlaps both the damper D and the second rotary electric machine 40 as viewed in the axial direction.

In the present embodiment, the fifth axis X5 as the rotation axis of the second gear mechanism 60 is located on the side opposite to the first axis X1 side with respect to the second reference plane P2. Both the entire fourth gear 62 and the entire second connecting shaft 63 of the second gear mechanism 60 are located on the side opposite to the first axis X1 side with respect to the second reference plane P2. A part of the third gear 61 of the second gear mechanism 60 is located on the first axis X1 side with respect to the second reference plane P2. Since the second gear mechanism 60 is provided separately from the first gear mechanism 50, the second gear mechanism 60 can be located in such a position that is away from the damper D as viewed in the axial direction.

Further, the fifth axis X5 is located on the second axis X2 side with respect to the first reference plane P1, and on the third axis X3 side with respect to the third reference plane P3. The entire second gear mechanism 60 is located on the second axis X2 side with respect to the first reference plane P1, and on the third axis X3 side with respect to the third reference plane P3. Further, the fifth axis X5 is located on the second axis X2 side (the upper side) with respect to the fourth reference plane P4, and on the third axis X3 side (the lower side) with respect to the fifth reference plane P5. Both the entire fourth gear 62 and the entire second connecting shaft 63 of the second gear mechanism 60 are located on the second axis X2 side (the upper side) with respect to the fourth reference plane P4, and on the third axis X3 side (the lower side) with respect to the fifth reference plane P5. The entire third gear 61 of the second gear mechanism 60 is located on the third axis X3 side (the lower side) with respect to the fifth reference plane P5, and a part of the third gear 61 is located on the third axis X3 side (the lower side) with respect to the fourth reference plane P4.

The major part of the second gear mechanism 60 is located in the space defined by the fourth reference plane P4, the second reference plane P2, and the fifth reference plane P5. The second gear mechanism 60 is disposed greatly away from the damper D as viewed in the axial direction and is disposed so as not to overlap the damper D as viewed in the axial direction. In this manner, according to the configuration of the present embodiment, although the second gear mechanism 60 tends to be axially elongated due to having a gear meshing with the second output gear 45 with a large maximum tangential force (the second maximum tangential force F2), the second gear mechanism 60 can be disposed away from the damper D that is disposed coaxially with the internal combustion engine E. Since such an arrangement configuration is adopted, it is possible to prevent interference between the second gear mechanism 60 and the damper D in the axial direction. Thus, as illustrated in FIG. 4, the second gear mechanism 60 can be disposed close to the damper D side in the axial direction, and hence the second gear mechanism 60 can be disposed close to the internal combustion engine E side.

Further, in the present embodiment, the second gear mechanism 60 that does not overlap the damper D as viewed in the axial direction is disposed so as to partially overlap the damper housing 3a and the damper D as viewed in the radial direction about the fifth axis X5. In this embodiment, an internal combustion engine E-side end of the second connecting shaft 63 of the second gear mechanism 60 is disposed so as to partially overlap the damper housing 3a and the damper D. More specifically, an end of the second connecting shaft 63 on the internal combustion engine E side with respect to the third gear 61 is disposed so as to partially overlap the damper housing 3a and the damper D. In this manner, the second gear mechanism 60 is disposed close enough to the internal combustion engine E side in the axial direction such that at least a part of the second gear mechanism 60 is located in the same axial position as those of the damper housing 3a and the damper D. Thus, the second rotary electric machine 40 can also be disposed close to the internal combustion engine E side in the axial direction.

Further, as mentioned above, each of the assumed maximum transmission torques T1 and T2 and the reference pitch radii R26 and R45 of the respective first output gear 26 and second output gear 45 is adjusted such that the first maximum tangential force F1 is less than the second maximum tangential force F2. Further, as illustrated in FIGS. 4 and 5, the gear width B1 of the first output gear 26 is less than the gear width B2 of the second output gear 45. Further, in accordance with this, the gear width of the first gear 51 meshing with the first output gear 26 is less than the gear width of the third gear 61 meshing with the second output gear 45. Thus, the axial length of the space occupied by the first gear mechanism 50 can be reduced in accordance with a reduction in the gear width of the first gear 51. Consequently, the second rotary electric machine 40 located at a position overlapping the first gear mechanism 50 as viewed in the axial direction can be disposed closer to the internal combustion engine E side.

Further, as described above, the gear width B3 of the input gear 71 is set to be less than the gear width B4 of the input gear 71 in the virtual structure illustrated in FIG. 6. Accordingly, the gear width of the second gear 52 and the fourth gear 62 meshing with the input gear 71 can also be reduced. Thus, the axial length of the first gear mechanism 50 can be further reduced, and the axial length of the second gear mechanism 60 can also be reduced. Accordingly, the second rotary electric machine 40 can be disposed closer to the internal combustion engine E side.

Thus, the axial length of the entire device along the second axis X2 can be reduced. Alternatively, as described above, a large second rotary electric machine 40 can be used without increasing the axial length of the entire device along the second axis X2.

### OTHER EMBODIMENTS

In the following, other embodiments of the vehicle drive device will be described. Note that the structure disclosed in each of the following embodiments may be applied in combination with the structures disclosed in the other embodiments as long as no inconsistency arises.

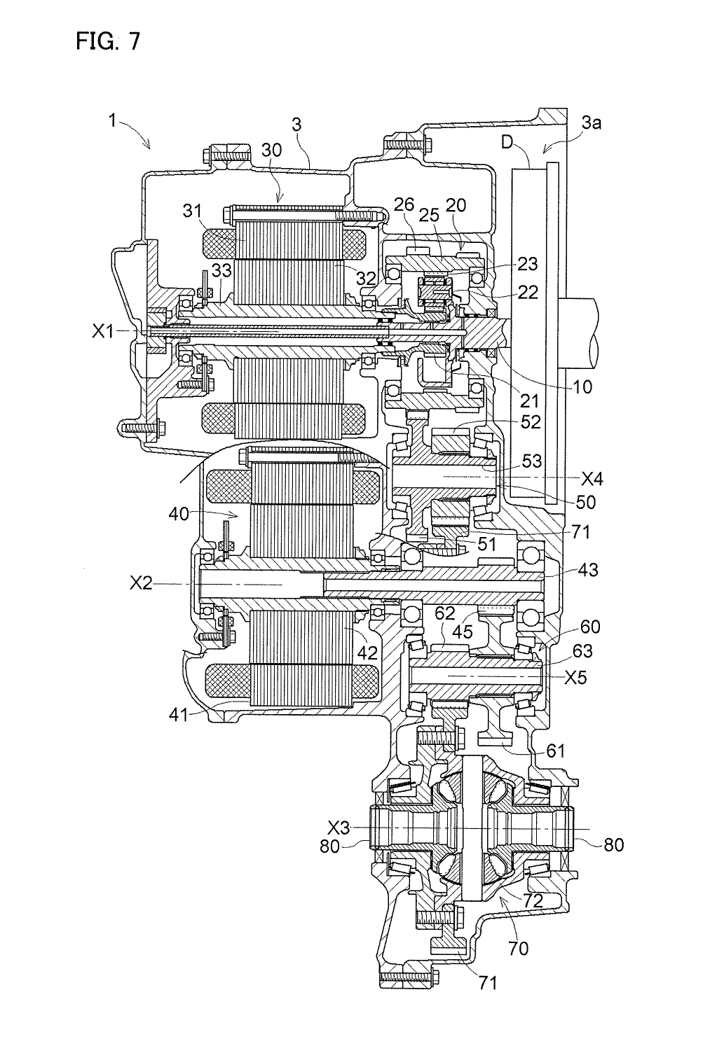

(1) In the above embodiment, an example has been described in which the first gear 51 of the first gear mechanism 50 is disposed on the internal combustion engine E side with respect to the second gear 52 in the axial direction. However, embodiments of the present invention are not limited thereto. For example, as illustrated in FIG. 7, the second gear 52 may be disposed on the internal combustion engine E side with respect to the first gear 51 in the axial direction. In the example of FIG. 7, in view of accommodating the entire device, the first output gear 26 is formed at a part on the side (the first rotary electric machine 30 side) opposite to the internal combustion engine E and damper D side with respect to the center position in the differential output member 25.

(2) In the above embodiment, an example has been described in which the second gear mechanism 60 (more specifically, an end of the second connecting shaft 63 on the internal combustion engine E side) is disposed so as to overlap the damper housing 3a and the damper D as viewed in the radial direction. However, embodiments of the present invention are not limited thereto. For example, the second gear mechanism 60 may be disposed so as to overlap only the damper housing 3a and not to overlap the damper D as viewed in the radial direction. Alternatively, the second gear mechanism 60 may be disposed on the differential gear device 20 side with respect to the damper housing 3a in the axial direction so as not to overlap either the damper housing 3a or the damper D as viewed in the radial direction. Further, not only the second connecting shaft 63 but also the first gear 61 may be disposed so as to overlap at least one of the damper housing 3a and the damper D as viewed in the radial direction.

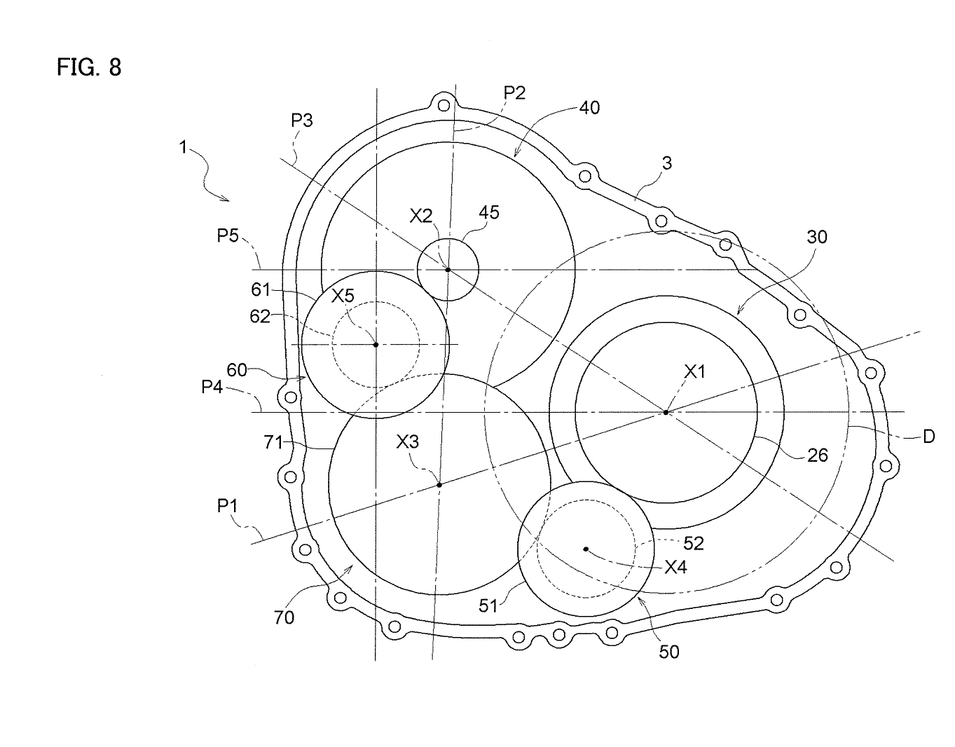

(3) In the above embodiment, an example has been described in which the fourth axis X4 as the rotation axis of the first gear mechanism 50 is disposed inside the triangular prism-shaped space defined by the three reference planes P1 through P3. However, embodiments of the present invention are not limited thereto. The fourth axis X4 may be disposed outside the triangular prism-shaped space defined by the three reference planes P1 through P3. For example, as illustrated in FIG. 8, the fourth axis X4 may be located on the side (the lower side) opposite to the second axis X2 side with respect to the first reference plane P1.

(4) In the above embodiment, an example has been described in which the main body unit 72 of the output device 70 is disposed on the internal combustion engine E side with respect to the input gear 71 in the axial direction. However, embodiments of the present invention are not limited thereto. For example, the main body unit 72 may be disposed on the side (the first rotary electric machine 30 and second rotary electric machine 40 side) opposite to the internal combustion engine E side with respect to the input gear 71 in the axial direction.

(5) In the above embodiment, an example has been described in which the second axis X2 and the third axis X3 that are disposed on one horizontal side with respect to the first axis X1 are located in the substantially same horizontal position as viewed in the axial direction, as illustrated in FIG. 3 and other figures. However, embodiments of the present invention are not limited thereto. The arrangement relationship between the three axes (the first axis X1, the second axis X2, and the third axis X3) may be arbitrarily set.

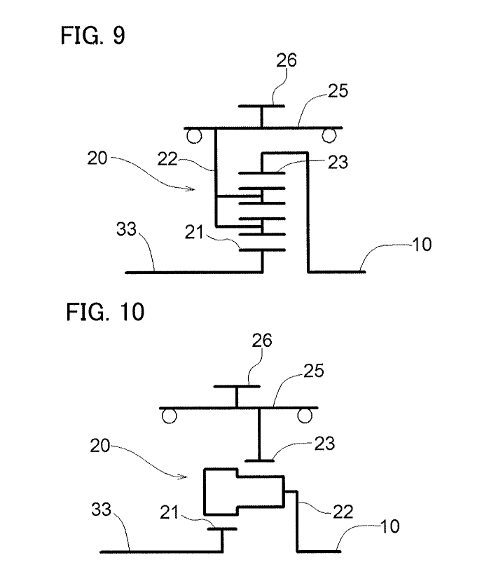

(6) In the above embodiment, an example has been described in which the differential gear device 20 is formed of a single-pinion type planetary gear mechanism. However, embodiments of the present invention are not limited thereto. Any specific structure may be employed as the differential gear device 20. For example, as illustrated in FIG. 9, the differential gear device 20 may be formed of a double-pinion type planetary gear mechanism. In this configuration, the three rotary elements of the differential gear device 20 include the sun gear 21, the ring gear 23, and the carrier 22 in order of rotational speed (velocity diagram omitted). The first rotary electric machine 30 is drivingly coupled to the sun gear 21 of the differential gear device 20; the input shaft 10 is drivingly coupled to the ring gear 23; and the output device 70 is drivingly coupled to the first output gear 26 that rotates together with the carrier 22. Alternatively, for example, as illustrated in FIG. 10, the differential gear device 20 may be formed of a planetary gear mechanism having a stepped pinion.

(7) In the above embodiment, an example has been described in which a preferred embodiment is applied to the vehicle drive device 1 including the differential gear device 20 functioning as a power distribution device. However, embodiments of the present invention are not limited thereto. For example, embodiments may be applied to a vehicle drive device 1 that includes a differential gear device 20 functioning as a so-called electric torque converter. Note that in the case where among the three rotary elements of the differential gear device 20, the rotary element drivingly coupled to the output device 70 is in the middle in order of rotational speed, the differential gear device 20 functions as an electric torque converter. In the case of the single-pinion type differential gear device 20, the first rotary electric machine 30 may be drivingly coupled to the sun gear 21; the output device 70 may be drivingly coupled to the first output gear 26 that rotates together with the carrier 22; and the input shaft 10 may be drivingly coupled to the ring gear 23, for example. In the case of the double-pinion type differential gear device 20, the first rotary electric machine 30 may be drivingly coupled to the sun gear 21; the output device 70 may be drivingly coupled to the first output gear 26 that rotates together with the ring gear 23; and the input shaft 10 may be drivingly coupled to the carrier 22, for example.

(8) Regarding other structures as well, the embodiments disclosed in the specification are merely examples in all respects, and it should be understood that the scope of the invention is not limited thereto. It will be readily apparent to those skilled in the art that various modifications and changes can be made without departing from the spirit of the invention. Accordingly, it is obvious that other embodiments that are modified without departing from the spirit of the invention are within the scope of the invention.

### DESCRIPTION OF THE REFERENCE NUMERALS

1 vehicle drive device
3a damper housing
10 input shaft (input member)
20 differential gear device
21 sun gear
22 carrier
23 ring gear (output element)
26 first output gear
30 first rotary electric machine
40 second rotary electric machine
45 second output gear
50 first gear mechanism
51 first gear
52 second gear
60 second gear mechanism
61 third gear
62 fourth gear
70 output device
71 input gear of output device
E internal combustion engine
D damper
W wheel
X1 first axis
X2 second axis
X3 third axis
X4 fourth axis
X5 fifth axis
P2 second reference plane (reference plane)
F1 first maximum tangential force
F2 second maximum tangential force
T1 assumed maximum transmission torque of first output gear
T2 assumed maximum transmission torque of second output gear
R26 reference pitch radius of first output gear (radius of first output gear)
R45 reference pitch radius of second output gear (radius of second output gear)
B1 gear width of first output gear
B2 gear width of second output gear

1-8. (canceled)

9. A vehicle drive device that includes an input member drivingly coupled to an internal combustion engine via a damper, a first rotary electric machine, a second rotary electric machine, a differential gear device having three rotary elements, and an output device drivingly coupled to wheels, wherein: the input member is drivingly coupled to a first one of the three rotary elements of the differential gear device; the first rotary electric machine is drivingly coupled to a second one of the rotary elements; and an output element as a third one of the rotary elements is drivingly coupled to the output device; and the second rotary electric machine is drivingly coupled to the output device, the vehicle drive device comprising:
a first gear mechanism including a first gear meshing with a first output gear that rotates together with the output element, and a second gear meshing with an input gear of the output device in a different axial position from the first gear; and
a second gear mechanism including a third gear meshing with a second output gear of the second rotary electric machine, and a fourth gear meshing with the input gear in a different axial position from the third gear; wherein:
the damper, the differential gear device, and the first rotary electric machine are arranged on a common first axis;
the second rotary electric machine is disposed on a second axis parallel to the first axis and different from the first axis;
the output device is disposed on a third axis parallel to the first axis and different from the first axis and the second axis;
the first gear mechanism is disposed on a fourth axis parallel to the first axis and different from the first axis, the second axis, and the third axis;
the second gear mechanism is disposed on a fifth axis parallel to the first axis and located on a side opposite to a first axis side with respect to a reference plane, the reference plane being a plane containing both the second axis and the third axis;
the third gear is disposed on a side opposite to a second rotary electric machine side with respect to the fourth gear in an axial direction; and
an assumed maximum transmission torque and a radius of each of the first output gear and the second output gear are set such that a first maximum tangential force is less than a second maximum tangential force, the first maximum tangential force being a tangential force in a case where the assumed maximum transmission torque is transmitted to the first output gear, the second maximum tangential force being a tangential force in a case where the assumed maximum transmission torque is transmitted to the second output gear.

10. The vehicle drive device according to claim 9, wherein a gear width of the first output gear and the first gear is less than a gear width of the second output gear and the third gear.

11. The vehicle drive device according to claim 10, wherein:
a virtual structure is assumed in which a virtual gear mechanism is provided in place of the first gear mechanism and the second gear mechanism, the virtual gear mechanism including a fifth gear meshing with both the first output gear and the second output gear, and a sixth gear meshing with the input gear in a different axial position from the fifth gear; and
a gear width of the input gear is set to be less than a gear width of the input gear that is set in accordance with a tangential force on the input gear in a case where an assumed maximum transmission torque is transmitted to the sixth gear in the virtual structure.

12. The vehicle drive device according to claim 11, wherein the second gear mechanism is disposed so as to overlap a damper housing that accommodates the damper as viewed in a radial direction, without overlapping the damper housing as viewed in the axial direction.

13. The vehicle drive device according to claim 12 wherein the first gear is disposed on a damper side with respect to the second gear in the axial direction.

14. The vehicle drive device according to claim 13, wherein in a vehicle-mounted state, the second axis and the third axis are disposed on one horizontal side with respect to the first axis, and the second axis is disposed above the third axis.

15. The vehicle drive device according to claim 9, wherein:
a virtual structure is assumed in which a virtual gear mechanism is provided in place of the first gear mechanism and the second gear mechanism, the virtual gear mechanism including a fifth gear meshing with both the first output gear and the second output gear, and a sixth gear meshing with the input gear in a different axial position from the fifth gear; and
a gear width of the input gear is set to be less than a gear width of the input gear that is set in accordance with a tangential force on the input gear in a case where an assumed maximum transmission torque is transmitted to the sixth gear in the virtual structure.

16. The vehicle drive device according to claim 15, wherein the second gear mechanism is disposed so as to overlap a damper housing that accommodates the damper as viewed in a radial direction, without overlapping the damper housing as viewed in the axial direction.

17. The vehicle drive device according to claim 16, wherein the first gear is disposed on a damper side with respect to the second gear in the axial direction.

18. The vehicle drive device according to claim 17, wherein in a vehicle-mounted state, the second axis and the third axis are disposed on one horizontal side with respect to the first axis, and the second axis is disposed above the third axis.

19. The vehicle drive device according to claim 9, wherein the second gear mechanism is disposed so as to overlap a damper housing that accommodates the damper as viewed in a radial direction, without overlapping the damper housing as viewed in the axial direction.

20. A vehicle drive device that includes an input member drivingly coupled to an internal combustion engine via a damper, a first rotary electric machine, a second rotary electric machine, a differential gear device having three rotary elements, and an output device drivingly coupled to wheels, wherein: the input member is drivingly coupled to a first one of the three rotary elements of the differential gear device; the first rotary electric machine is drivingly coupled to a second one of the rotary elements; and an output element as a third one of the rotary elements is drivingly coupled to the output device; and the second rotary electric machine is drivingly coupled to the output device, the vehicle drive device comprising:
a first gear mechanism including a first gear meshing with a first output gear that rotates together with the output element, and a second gear meshing with an input gear of the output device in a different axial position from the first gear; and
a second gear mechanism including a third gear meshing with a second output gear of the second rotary electric machine, and a fourth gear meshing with the input gear in a different axial position from the third gear; wherein:
the damper, the differential gear device, and the first rotary electric machine are arranged on a common first axis;
the second rotary electric machine is disposed on a second axis parallel to the first axis and different from the first axis;
the output device is disposed on a third axis parallel to the first axis and different from the first axis and the second axis;
the first gear mechanism is disposed on a fourth axis parallel to the first axis and different from the first axis, the second axis, and the third axis;
the second gear mechanism is disposed on a fifth axis parallel to the first axis and located on a side opposite to a first axis side with respect to a reference plane, the reference plane being a plane containing both the second axis and the third axis;
the third gear is disposed on a side opposite to a second rotary electric machine side with respect to the fourth gear in an axial direction; and
a gear width of the first output gear and the first gear is less than a gear width of the second output gear and the third gear.

21. The vehicle drive device according to claim 20, wherein:
a virtual structure is assumed in which a virtual gear mechanism is provided in place of the first gear mechanism and the second gear mechanism, the virtual gear mechanism including a fifth gear meshing with both the first output gear and the second output gear, and a sixth gear meshing with the input gear in a different axial position from the fifth gear; and
a gear width of the input gear is set to be less than a gear width of the input gear that is set in accordance with a tangential force on the input gear in a case where an assumed maximum transmission torque is transmitted to the sixth gear in the virtual structure.

22. The vehicle drive device according to claim 21, wherein the second gear mechanism is disposed so as to overlap a damper housing that accommodates the damper as viewed in a radial direction, without overlapping the damper housing as viewed in the axial direction.

23. The vehicle drive device according to claim 22, wherein the first gear is disposed on a damper side with respect to the second gear in the axial direction.

24. The vehicle drive device according to claim 23, wherein in a vehicle-mounted state, the second axis and the third axis are disposed on one horizontal side with respect to the first axis, and the second axis is disposed above the third axis.

25. The vehicle drive device according to claim 20, wherein the second gear mechanism is disposed so as to overlap a damper housing that accommodates the damper as viewed in a radial direction, without overlapping the damper housing as viewed in the axial direction.

26. The vehicle drive device according to claim 25, wherein the first gear is disposed on a damper side with respect to the second gear in the axial direction.

27. The vehicle drive device according to claim 26, wherein in a vehicle-mounted state, the second axis and the third axis are disposed on one horizontal side with respect to the first axis, and the second axis is disposed above the third axis.

28. The vehicle drive device according to claim 20, wherein the first gear is disposed on a damper side with respect to the second gear in the axial direction.
